(19) United States
(12) Patent Application Publication
(10) Pub. No.: US 2017/0243416 A1
(43) Pub. Date: Aug. 24, 2017

(54) DOOR ACCESS MANAGEMENT METHOD AND DOOR ACCESS MANAGEMENT SYSTEM

(71) Applicant: TAIWAN FU HSING INDUSTRIAL CO., LTD., Kaohsiung City (TW)

(72) Inventors: Pei-Huan Chen, Kaohsiung City (TW); Tzu-Yang Lin, Kaohsiung City (TW); Shih-Min Lu, Kaohsiung City (TW); I-Pei Kuo, New Taipei City (TW)

(21) Appl. No.: 15/193,115

(22) Filed: Jun. 27, 2016

(30) Foreign Application Priority Data
Feb. 19, 2016 (TW) 105104870

(51) Int. Cl. G07C 9/00

(52) U.S. Cl. CPC G07C 9/00103; G07C 9/00571

(57) ABSTRACT

The present invention provides a door access management method applicable to a building. The building includes a plurality of areas. The door access management method includes setting access information of an access card, the access information marking accessible entrances of the access card in the building; arranging an electronic lock on a door for controlling access of an entrance of a corresponding area in the building; the electronic lock storing information of the entrance controlled by the electronic lock; the electronic lock sensing the access card for receiving the access information of the access card; the electronic lock comparing the access information with the information of the entrance controlled by the electronic lock; and unlocking the electronic lock when an accessible entrance marked by the access information corresponds to the information of the entrance controlled by the electronic lock.

### BACKGROUND OF THE INVENTION

1. Field of the Invention

The present invention relates to a door access management method and a door access management system, and more particularly, to a door access management method and a door access management system capable of simplifying hardware structure.

2. Description of the Prior Art

A door access management system is configured to control access of multiple areas in a building (such as a residential building or a hotel). In the prior art, a door access management system comprises a host and a plurality of electronic locks linked to the host. After the host sets identification information in an access card, the host transmits the identification information of the access card to the electronic locks corresponding to the access card, in order to allow a user to use the access card to pass through entrances of areas controlled by the electronic locks corresponding to the access card. However, for updating the identification information in the electronic locks at any time, the electronic locks must be linked to the host in a wired or wireless manner. The building needs to be installed with cables or wireless transmission modules in advance for linking the electronic locks to the host. Therefore, the door access management system of the prior art has more complex hardware structure and higher installation cost.

### SUMMARY OF THE INVENTION

The present invention provides a door access management method applicable to a building. The building comprises a plurality of areas. The door access management method comprises setting access information of an access card, the access information marking accessible entrances of the access card in the building; arranging an electronic lock on a door for controlling access of an entrance of a corresponding area in the building; the electronic lock storing information of the entrance controlled by the electronic lock; the electronic lock sensing the access card for receiving the access information of the access card; the electronic lock comparing the access information with the information of the entrance controlled by the electronic lock; and unlocking the electronic lock when an accessible entrance marked by the access information corresponds to the information of the entrance controlled by the electronic lock.

The present invention further provides a door access management system applicable to a building. The building comprises a plurality of areas. The door access management system comprises a host and a plurality of electronic locks. The host is configured to set access information of an access card, and the access information marks accessible entrances of the access card in the building. Each of the electronic locks is arranged on a door for controlling access of an entrance of a corresponding area in the building. The electronic lock comprises a storage unit configured to store information of the entrance controlled by the electronic lock; a sensing unit configured to sense the access card for receiving the access information of the access card; and a processing unit configured to control operations of the electronic lock according to the access information and the information of the entrance controlled by the electronic lock, wherein the processing unit unlocks the electronic lock when an accessible entrance marked by the access information corresponds to the information of the entrance controlled by the electronic lock.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a door access management system of the present invention.

FIG. 2 is a diagram showing area arrangement of a building.

FIG. 3 is a functional block diagram of an electronic lock of the present invention.

FIG. 4 is a diagram illustrating the door access management system of the present invention inputting setting information into the electronic lock.

FIG. 5 is a flowchart showing a door access management method of the present invention.

### DETAILED DESCRIPTION

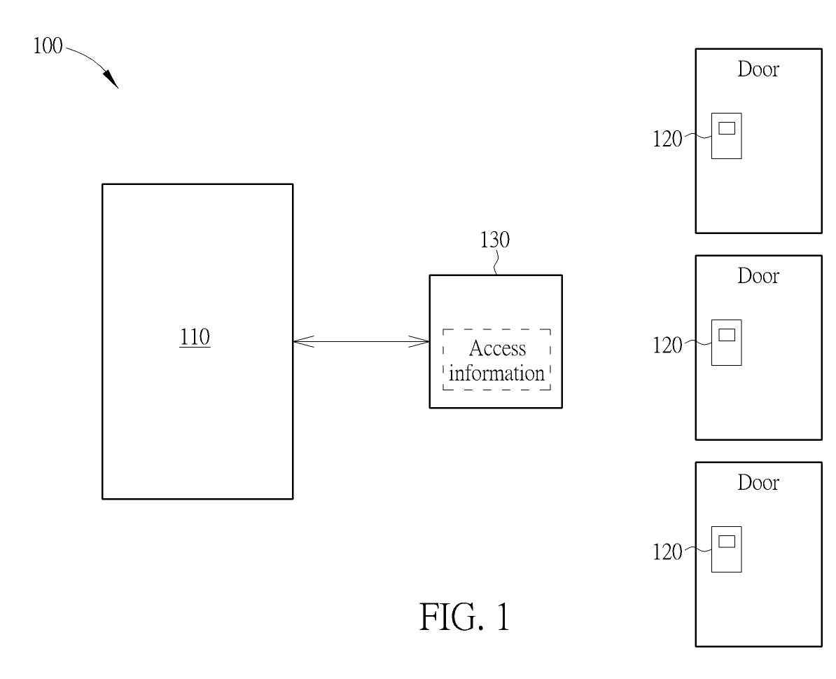

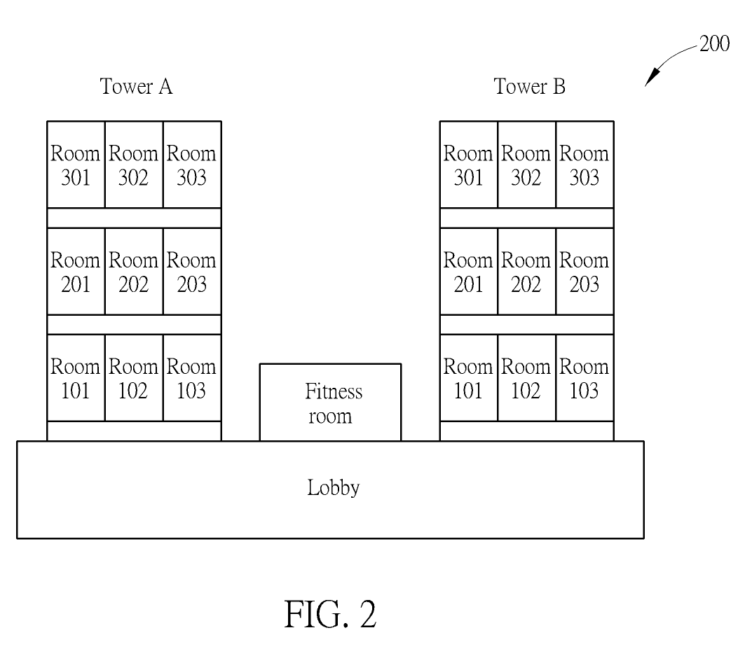

Please refer to FIG. 1 and FIG. 2. FIG. 1 is a diagram showing a door access management system of the present invention. FIG. 2 is a diagram showing area arrangement of a building. As shown in figures, the door access management system 100 of the present invention comprises a host 110 and a plurality of electronic locks 120. The door access management system 100 of the present invention is applicable to a building 200. The building 200 comprises a plurality of areas, such as a lobby, a fitness room, a tower A and a tower B. Each of the areas has an entrance. The host 110 is configured to set access information of an access card (such as setting access information of an access card 130 through a card issuing machine). The access information is configured to mark accessible entrances of the access card 130 in the building 200. For example, when a user of the access card 130 is a resident of room 203 in the tower A, the access information is configured to mark “door of lobby”, “door of tower A” and “door of room 203 in tower A” (or “lobby”, “tower A”, “room 203 in tower A”) in the access card 130; and when the user of the access card 130 is a member of the fitness room, the access information is configured to mark “door of fitness room” (or “fitness room”) in the access card 130. In the embodiment of the present invention, the identification name of the entrance marked by the access information is not limited to a real name. The identification name of the entrance marked by the access information can also be represented by a specific code. On the other hand, the access card 130 can store a table containing identification names of all entrances in the building 200, and the access information is configured to mark accessible entrances of the access card 130 in the building 200 on the table. Each of the electronic cards 120 is arranged on a door for controlling access of an entrance of a corresponding area in the building 200.

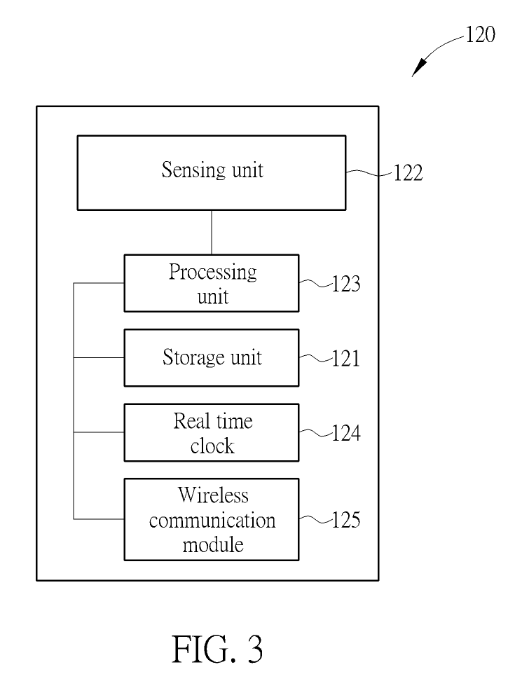

Please refer to FIG. 3, and refer to FIG. 1 and FIG. 2 as well. FIG. 3 is a functional block diagram of the electronic lock of the present invention. As shown in FIG. 3, the electronic lock 120 comprises a storage unit 121, a sensing unit 122 and a processing unit 123. The storage unit 121 is configured to store information of the entrance controlled by the electronic lock, such as an identification name of the area accessed through the entrance and/or an identification name of the door. For example, when the electronic lock 120 is arranged on the door at the entrance of the lobby, the information of the entrance controlled by the electronic lock can be “lobby” (or “door of lobby”); when the electronic lock 120 is arranged on the door at the entrance of the tower A, the information of the entrance controlled by the electronic lock can be “tower A” (or “door of tower A”); and when the electronic lock 120 is arranged on the door at the entrance of room 203 in the tower A, the information of the entrance controlled by the electronic lock can be “room 203 in tower A” (or “door of room 203 in tower A”). In the embodiment of the present invention, the information of the entrance controlled by the electronic lock is not limited to a real name. The information of the entrance controlled by the electronic lock can also be represented by a specific code. The sensing unit 122 is configured to sense the access card 130 for receiving the access information of the access card 130. The sensing unit 122 can communicate with the access card 130 through a radio frequency technique. For example, the sensing unit 122 can be a near field communication (NFC) sensing unit, and the access card 130 can be a near field communication sensing card, but the present invention is not limited thereto. The sensing unit 122 can also communicate with the access card 130 through other radio frequency technique (such as Mifare). When the access card 130 is placed close to the sensing unit 122, the sensing unit 122 senses the access card 130 and further receives the access information of the access card 130. The processing unit 123 is configured to control operations of the electronic lock 120 according to the access information and the information of the entrance controlled by the electronic lock. The processing unit 123 can compare the access information with the information of the entrance controlled by the electronic lock. When an accessible entrance marked by the access information corresponds to the information of the entrance controlled by the electronic lock, the processing unit 123 unlocks the electronic lock 120, in order to allow the user of the access card 130 to pass through the entrance controlled by the electronic lock 120. For example, when the user of the access card 130 is a resident of room 203 in the tower A, the access information can mark “lobby”, “tower A”, “room 203 in tower A” (or mark fields of the lobby, the tower A and the room 203 in the tower A in the table of the access card to indicate the accessible entrances) in the access card 130. Therefore, when the user take the access card 130 to pass through the door of the lobby, the door of the tower A and the door of room 203 in the tower A, the processing units 123 of the electronic locks 120 at the entrances of the lobby, the tower A and the room 203 in the tower A determine that the accessible entrances marked by the access information correspond to the information of the entrances controlled by the electronic locks 120, so as to unlock the electronic locks 120 to allow the user of the access card 130 to pass through. When the processing unit 123 compares the access information with the information of the entrance controlled by the electronic lock, and the information of the entrance controlled by the electronic lock is “tower A”, the processing unit 123 can directly check whether the field of the tower A in the table of the access card is marked without checking a field of the tower B or fields of other areas, so as to greatly increase judging speed of unlocking. Similarly, when the user of the access card 130 is a member of the fitness room, the access information can mark “fitness room” (or mark a field of the fitness room in the table of the access card to indicate the accessible entrances) in the access card 130. Therefore, when the user takes the access card 130 to pass through the door of the fitness room, the processing unit 123 of the electronic lock 120 at the entrance of the fitness room determines that the accessible entrance marked by the access information corresponds to the information of the entrance controlled by the electronic lock, so as to unlock the electronic lock 120 to allow the user of the access card 130 to pass through.

On the other hand, when the user takes the access card 130 to pass through the entrance not marked by the access information, the accessible entrance marked by the access information does not correspond to the information of the entrance controlled by the electronic lock, thus the processing unit 123 does not unlock the electronic lock 120.

When an area has multiple entrances, the access information can further mark the accessible entrances in a same area, and the information of the entrances controlled by the electronic locks in the same area can be different. For example, when the fitness room has two entrances, such as a front door and a rear door, and a general member is not allowed to pass through the rear door, the access information can mark “front door of fitness room” in the access card 130 of the general member without marking “rear door of fitness room”. The information of the entrances controlled by the electronic locks at the front entrance and the rear entrance of the fitness room can be “front door of fitness room” and “rear door of fitness room” respectively. When the general member takes the access card 130 to pass through the front door of the fitness room, the processing unit 123 of the electronic lock 120 on the front door of the fitness room determines that the accessible entrance marked by the access information corresponds to the information of the entrance controlled by the electronic lock, so as to unlock the electronic lock 120 on the front door of the fitness room to allow the general member of the access card 130 to pass through. When the general member takes the access card 130 to pass through the rear door of the fitness room, the processing unit 123 of the electronic lock 120 on the rear door of the fitness room determines that the accessible entrance marked by the access information does not correspond to the information of the entrance controlled by the electronic lock, thus the processing unit 123 does not unlock the electronic lock 120 on the rear door of the fitness room.

In addition, the electronic lock 120 can further comprise a real time clock (RTC) 124 configured to indicate real time, and the storage unit 121 is further configured to store accessible time of the entrance controlled by the electronic lock. When the storage unit 121 further stores accessible time of the entrance controlled by the electronic lock, the processing unit 123 must further determine whether the accessible time of the entrance controlled by the electronic lock corresponds to time indicated by the real time clock 124, in order to unlock the electronic lock 120. For example, the storage unit 121 of the electronic lock 120 at the entrance of the fitness room can further store accessible time of the entrance of the fitness room. When the electronic lock 120 at the entrance of the fitness room receives the access information of the access card 130, the processing unit 123 not only determines whether the accessible entrance marked by the access information corresponds to the information of the entrance of the fitness room, but also determines whether the accessible time of the entrance of the fitness room corresponds to the time indicated by the real time clock 124. When the member of the fitness room is going to enter the fitness room within a range of the accessible time through the entrance of the fitness room, the processing unit 123 unlocks the electronic lock 120 to allow the member of the fitness room to pass through; and when the member of the fitness room is going to enter the fitness room outside the range of the accessible time through the entrance of the fitness room, the processing unit 123 does not unlock the electronic lock 120 even the accessible entrance marked by the access information corresponds to the information of the entrance of the fitness room.

Moreover, in addition to marking accessible entrances of the access card 130 in the building 200, the access information can further mark a use period of the access card 130. When the access information further marks the use period of the access card 130, the processing unit 123 must further determine whether the use period of the access card 130 corresponds to the time indicated by the real time clock 124, in order to unlock the electronic lock 120. For example, when a visitor is going to enter the building 200, the host can set access information in a temporary access card, and the access information in the temporary access card is configured to not only marks accessible entrances of the temporary access card in the building 200, but also mark a use period of the temporary access card. When the user of the temporary access card is going to pass through the accessible entrances within the use period, the processing unit 123 unlocks the electronic lock 120 to allow the user of the temporary access card to pass through; and when the user of the temporary access card is going to pass through the accessible entrances outside the use period, the processing unit 123 does not unlock the electronic lock 120 even the accessible entrance marked by the access information corresponds to the information of the entrance controlled by the electronic card. As such, the visitor can be prevented from entering the building 200 outside the use period of the temporary access card.

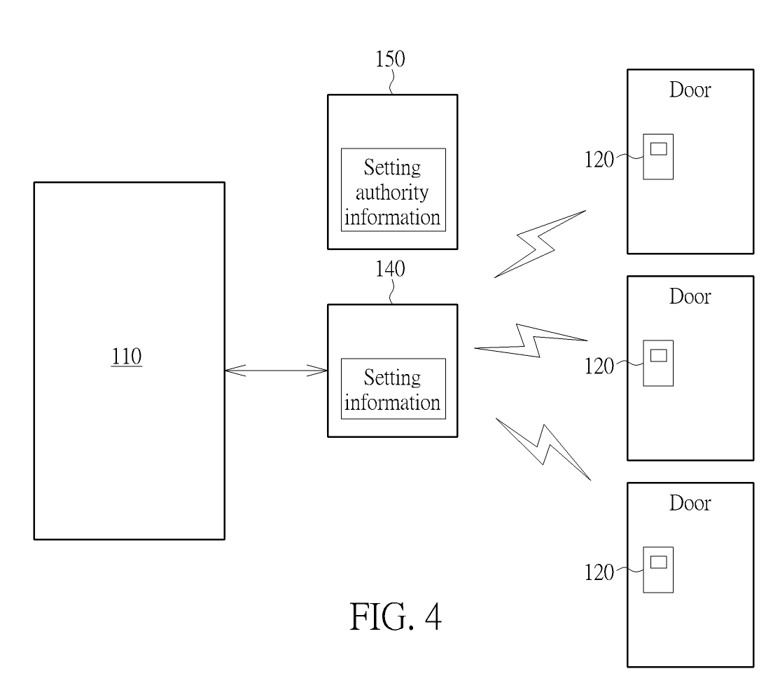

On the other hand, the electronic lock can further comprise a wireless communication module 125 (such as a Bluetooth module or other short distance wireless communication module) configured to receive setting information from a portable electronic device 140. For example, as shown in FIG. 4, a building administrator can use the host 110 to generate information of the entrance controlled by each electronic lock, and further transmits the information of the entrance controlled by each electronic lock to a portable electronic device 140, which is installed with application programs for communicating with the host 110 and the electronic lock 120 to receive/transmit the setting information. The building administrator can further take a setting card 150 stored with setting authority information to set the electronic lock 120. When the sensing unit 122 of the electronic lock 120 senses the setting card 150 and receives the setting authority information, the processing unit 123 wakes up the wireless communication module 125. Thereafter, the building administrator can use the portable electronic device 140 to transmit the information of the entrance controlled by the electronic lock to the wireless communication module 125 of the electronic lock 120, and the information of the entrance controlled by the electronic lock can be further stored in the storage unit 121. Similarly, the building administrator can also use the setting card 150 and the portable electronic device 140 to input the accessible time of the entrance controlled by the electronic lock to the storage unit 121 of the corresponding electronic lock 120. In addition, when the portable electronic device 140 transmits the setting information to the electronic lock 120, the processing unit 123 of the electronic lock 120 can calibrate the time indicated by the real time clock 124 of the electronic lock 120 according to time information on the portable electronic device 140. On the other hand, the setting card 150 is not necessary. In other embodiment of the present invention, the setting authority information can be stored in the portable electronic device 140. The portable electronic device 140 can use related radio frequency technique to transmit the setting authority information to the sensing unit 122 of the electronic lock 120 in order to wake up the wireless communication module 125, and further transmit the setting information to the wireless communication module 125 of the electronic lock 120.

According to the above arrangement, after installing all the electronic locks 120 in the building 200, the building administrator can use the portable electronic device 140 to transmit the setting information to the corresponding electronic locks 120 one by one. Since the setting information in each of the electronic locks 120 is fixed, the setting information is not required to be updated at any time. Therefore, the electronic locks 120 of the door access management system 100 of the present invention do not need to link to the host 110. In other words, the door access management system 100 of the present invention does not require cables or wireless transmission modules to be installed in the building in advance. Thus the door access management system 100 of the present invention has simpler hardware structure and lower installation cost.

In addition, in order to prevent the access card 130 from being used by an unauthorized person, when the access card 130 is lost, the building administrator can use the setting card 150 and the portable electronic device 140 to input an identification number of the lost access card 130 into the electronic locks 120 corresponding to the accessible entrances marked by the access information in the lost access card 130, such that the identification number of the lost access card 130 is listed in a blacklist. Therefore, when the unauthorized person is going to enter the building 200 by the lost access card 130, the processing unit 123 of the electronic lock 120 can determine whether the identification number of the access card 130 matches the identification number in the blacklist. When the identification number of the access card 130 matches the identification number in the blacklist, the processing unit 123 does not unlock the electronic lock 120.

On the other hand, in order to prevent the access card 130 from opening doors of another building due to identical format of the access information, the host 110 can further set building information in the access card 130. The storage unit 121 of the electronic lock 120 can also store the building information. When the building information in the access card 130 does not match the building information in the storage unit 121, the processing unit 123 does not unlock the electronic lock 120.

In the above embodiments, area arrangement and area names in the building 200 are illustrated for example, the present invention is not limited thereto. The door access management 100 of the present invention can be applied to different types of buildings, such as hotels, hospitals, office buildings or residential buildings.

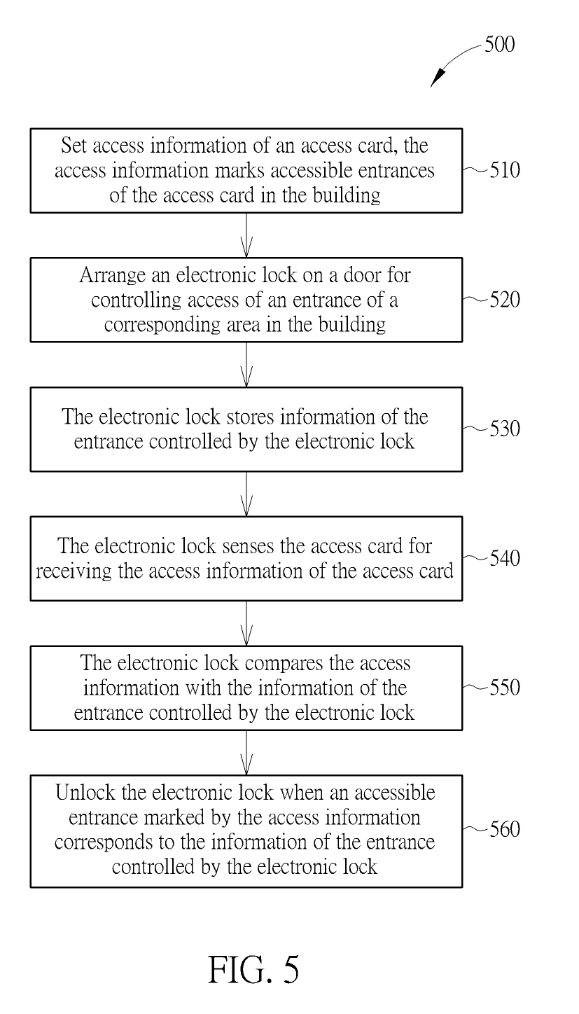

Please refer to FIG. 5. FIG. 5 is a flowchart 500 showing a door access management method of the present invention. The flowchart of the door access management method of the present invention comprises the following steps:

Step 510: Set access information of an access card, the access information marks accessible entrances of the access card in the building;

Step 520: Arrange an electronic lock on a door for controlling access of an entrance of a corresponding area in the building;

Step 530: The electronic lock stores information of the entrance controlled by the electronic lock;

Step 540: The electronic lock senses the access card for receiving the access information of the access card;

Step 550: The electronic lock compares the access information with the information of the entrance controlled by the electronic lock; and

Step 560: Unlock the electronic lock when an accessible entrance marked by the access information corresponds to the information of the entrance controlled by the electronic lock.

In addition, the steps of the flowchart 500 need not be in the exact order shown and need not be contiguous, that is, other steps can be inserted between.

In contrast to the prior art, the door access management method of the present invention marks accessible entrances in the access card and stores information of the entrance controlled by the electronic lock in the electronic lock, in order to perform door access management. As such, the setting information in each electronic lock does not need to be updated at any time, and the electronic lock of the door access management system of the present invention is no longer required to link to the host. Therefore, the door access management system of the present invention has simpler hardware structure and lower installation cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A door access management method applicable to a building, the building comprising a plurality of areas, the door access management method comprising:
setting access information of an access card, the access information marking accessible entrances of the access card in the building;
arranging an electronic lock on a door for controlling access of an entrance of a corresponding area in the building;
the electronic lock storing information of the entrance controlled by the electronic lock;
the electronic lock sensing the access card for receiving the access information of the access card;
the electronic lock comparing the access information with the information of the entrance controlled by the electronic lock; and
unlocking the electronic lock when an accessible entrance marked by the access information corresponds to the information of the entrance controlled by the electronic lock.

2. The door access management method of claim 1 further comprising:
the electronic lock storing accessible time of the entrance controlled by the electronic lock; and
unlocking the electronic lock when the accessible entrance marked by the access information corresponds to the information of the entrance controlled by the electronic lock and the accessible time of the entrance controlled by the electronic lock corresponds to time indicated by a real time clock.

3. The door access management method of claim 1, wherein the access information is configured to mark the accessible entrances of the access card in the building and a use period of the access card, the door access management method further comprises:
unlocking the electronic lock when the accessible entrance marked by the access information corresponds to the information of the entrance controlled by the electronic lock and the use period of the access card corresponds to time indicated by a real time clock.

4. The door access management method of claim 1 further comprising the electronic lock receiving the information of the entrance controlled by the electronic lock from a portable electronic device.

5. The door access management method of claim 1 further comprising the electronic lock receiving an identification number of the access card from a portable electronic device, in order to prohibit the access card from accessing the entrance controlled by the electronic lock.

6. The door access management method of claim 1, wherein the information of the entrance controlled by the electronic lock comprises an identification name of the area accessed through the entrance and/or an identification name of the door.

7. A door access management system applicable to a building, the building comprising a plurality of areas, the door access management system comprising:
a host, configured to set access information of an access card, the access information marking accessible entrances of the access card in the building; and
a plurality of electronic locks, each of the electronic locks is arranged on a door for controlling access of an entrance of a corresponding area in the building, the electronic lock comprising:
a storage unit, configured to store information of the entrance controlled by the electronic lock;
a sensing unit, configured to sense the access card for receiving the access information of the access card; and
a processing unit, configured to control operations of the electronic lock according to the access information and the information of the entrance controlled by the electronic lock, wherein the processing unit unlocks the electronic lock when an accessible entrance marked by the access information corresponds to the information of the entrance controlled by the electronic lock.

8. The door access management system of claim 7, wherein the electronic lock further comprises a real time clock, the storage unit is further configured to store accessible time of the entrance controlled by the electronic lock, the processing unit unlocks the electronic lock when the accessible entrance marked by the access information corresponds to the information of the entrance controlled by the electronic lock and the accessible time of the entrance controlled by the electronic lock corresponds to time indicated by the real time clock.

9. The door access management system of claim 7, wherein the electronic lock further comprises a real time clock, the access information is configured to mark the accessible entrances of the access card in the building and a use period of the access card, the processing unit unlocks the electronic lock when the accessible entrance marked by the access information corresponds to the information of the entrance controlled by the electronic lock and the use period of the access card corresponds to time indicated by a real time clock.

10. The door access management system of claim 7, wherein the electronic lock further comprises a wireless communication module, configured to receive the information of the entrance controlled by the electronic lock from a portable electronic device.

11. The door access management system of claim 7, wherein the information of the entrance controlled by the electronic lock comprises an identification name of the area accessed through the entrance and/or an identification name of the door.

12. The door access management system of claim 7, wherein the plurality of electronic locks is not linked to the host.
